(19) United States
(12) Patent Application Publication
(10) Pub. No.: US 2011/0104403 A1
(43) Pub. Date: May 5, 2011

(54) MASCOT OR CHARACTER DEVICE USED IN COMBINATION WITH A VEHICLE

(76) Inventor: Ronald Mark Thick, Concord, MI (US)

(21) Appl. No.: 12/912,856

(22) Filed: Oct. 27, 2010

Related U.S. Application Data
(60) Provisional application No. 61/256,906, filed on Oct. 30, 2009.

(51) Int. Cl. B60R 13/00; B23P 17/04

(52) U.S. Cl. 428/31; 29/428

(57) ABSTRACT

The present invention is a mascot or character device used in combination with a vehicle, with an attachment pole. The device includes a mascot or character that includes a jersey and an attachment webbing and harness that secures the mascot or character to the attachment pole. The attachment webbing and harness has a harness portion that is wrapped around the mascot or character being secured to the attachment pole, two generally elongated strips that are attached to the harness portion and a loop formed on an end of each the generally elongated strips to accommodate the attachment pole that the attachment webbing and harness is attached to. The device can also be attached to the vehicle without a pole as well with an attachment assembly that includes a strap with an adjustable buckle.

This application claims priority to U.S. Provisional Application 61/256,906 filed on Oct. 30, 2009, the entire disclosure of which is incorporated by reference.

### TECHNICAL FIELD & BACKGROUND

The present invention generally relates to a mascot or character device. More specifically, the invention is related to a mascot or character device used in combination with a vehicle.

It is an object of the invention to provide a mascot or character device used in combination with a vehicle to promote fan and team spirit.

It is an object of the invention to provide a mascot or character device used in combination with a vehicle that is disposed on the outside of a vehicle.

It is an object of the invention to provide a mascot or character device used in combination with a vehicle that serves as vehicle decoration.

It is an object of the invention to provide a mascot or character device used in combination with a vehicle that promote holiday season(s) or a favored theme.

It is an object of the invention to provide a mascot or character device used in combination with a vehicle that serves as a toy for adults.

It is an object of the invention to provide a mascot or character device used in combination with a vehicle that serves as a toy for children that is removable from an attachment pole provided as part of the vehicle.

What is really needed is a mascot or character device used in combination with a vehicle that promote fan and team spirit, that is disposed on the outside of a vehicle, that serves as vehicle decoration, that promote holiday season(s) or a favored theme, that serves as a toy for adults and that serves as a toy for children that is removable from a attachment pole provided as part of the vehicle.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates a front side environmental perspective view of an attachment assembly of a mascot or character device used in combination with a vehicle attached to an overhead handle of the vehicle, in accordance with one embodiment of the present invention.

FIG. 1B illustrates a front environmental perspective view of an attachment assembly of a mascot or character device used in combination with a vehicle to an overhead hook of the vehicle, in accordance with one embodiment of the present invention.

FIG. 2A illustrates a side perspective view of a mascot or character device used in combination with a vehicle attached to an attachment pole on an exterior of a vehicle, in accordance with one embodiment of the present invention.

FIG. 2B illustrates a front perspective view of a mascot or character device used in combination with a vehicle attached to an attachment pole on an exterior of a vehicle, in accordance with one embodiment of the present invention.

FIG. 2C illustrates a front perspective view of an attachment webbing and harness for a mascot or character device used in combination with a vehicle that attaches to an attachment pole on an exterior of the vehicle, in accordance with one embodiment of the present invention.

FIG. 3A illustrates a front perspective view of a mascot or character device used in combination with a vehicle attached to a trunk hinge of a vehicle, in accordance with one embodiment of the present invention.

FIG. 3B illustrates a front perspective view of a mascot or character device used in combination with a vehicle attached to a trunk hinge of a vehicle, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

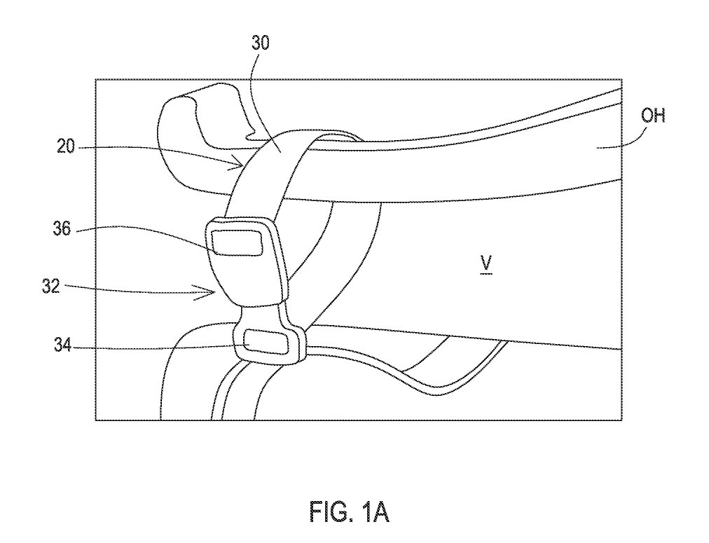

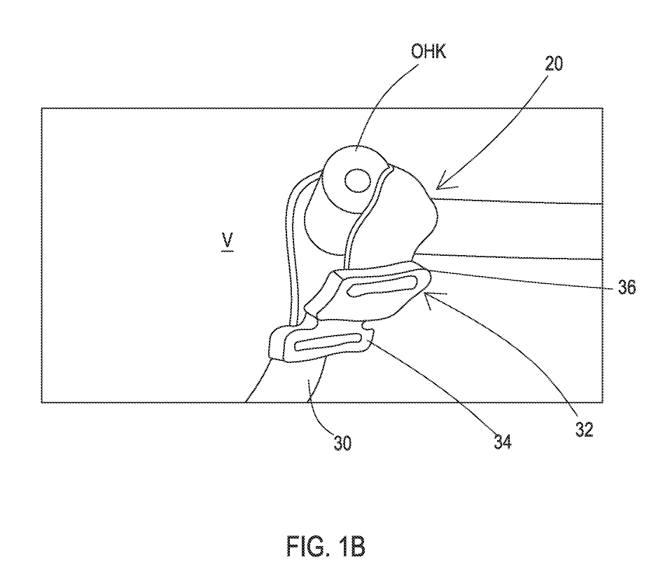

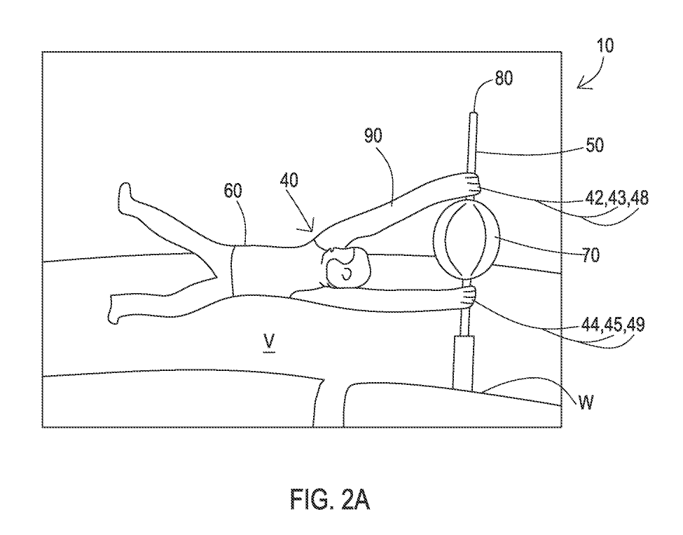

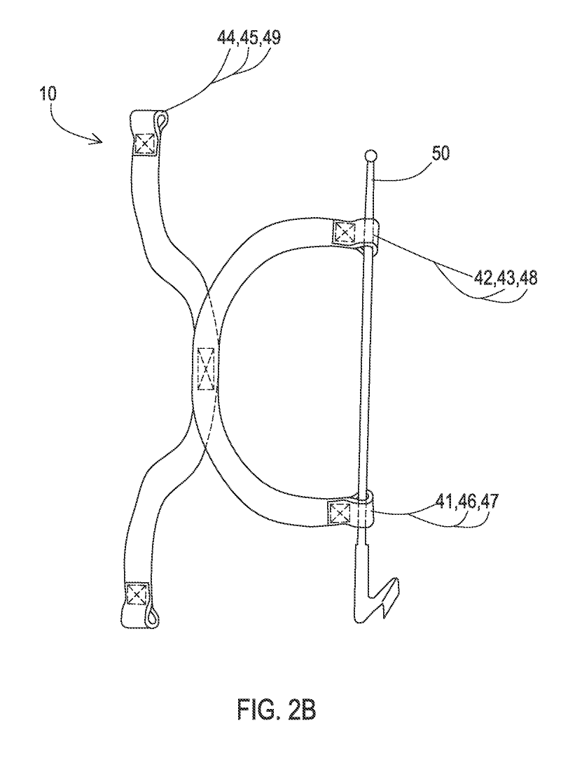

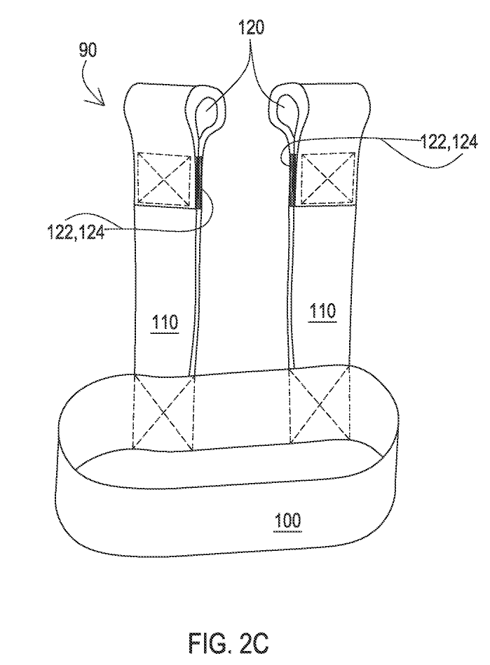

FIG. 1A illustrates a front side environmental perspective view of an attachment assembly 20 for an overhead handle OH of a vehicle V, in accordance with one embodiment of the present invention. The attachment assembly 20 includes a strap 30 with an adjustable buckle 32 where the strap 30 can be pulled through the adjustable buckle 32 at any length and the adjustable buckle 32 has a male end 34 that can be inserted into a female end 36 forming a secured but releasable adjustable buckle 32 and attachment assembly 20. The attachment assembly 20 is used to attach a mascot or character 40 (FIG. 2A) to the overhead handle OH. Any attachment assembly 20 that is known in the art can be used in combination with the overhead handle OH.

FIG. 1B illustrates a front environmental perspective view of an attachment assembly 20 attached to an overhead hook OHK of a vehicle V, in accordance with one embodiment of the present invention. All of the features of the attachment assembly 20, such as the strap 30, the adjustable buckle 32 with the male end 34 and female end 36 are the same in FIG. 1A. However, the attachment assembly 20 can be used in combination with an overhead hook OHK of a vehicle V also to attach a mascot or character (FIG. 2A, 40).

FIG. 2A illustrates a front environmental perspective view of a mascot or character device 10 used in combination with a vehicle V attached to a attachment pole 50 on an exterior EX of a vehicle V, in accordance with one embodiment of the present invention. The attachment pole 50 is made of plastic, but can be made of any material that is well known in the art. The mascot or character device 10 includes a mascot or character 40 which includes clothes and accessories such as football, basketball and soccer jerseys 60 or other jerseys that are well known in the art. The mascot or character 40 hangs on the attachment pole 50 by placing a first hand 42 from the mascot or character 40 on the attachment pole 50 first and then sliding an attachment accessory 70 on the attachment pole 50. The attachment accessory 70 can be a basketball, a football, a golf ball, a hockey puck, a soccer ball, a bottle of beer, cola, pop or soda, a honey pot, a pineapple or other attachment accessory 70 that is well known in the art. The attachment accessory 70 can be removed at any time and the mascot or character device 10 does not require an attachment accessory 70.

A second hand 44 from the mascot or character 40 is then placed on the attachment pole 50 and a C-clamp 80 is then disposed on the top of the attachment pole 50 and secures both hands 42,44 and the attachment accessory 70 on the attachment pole 50 if desired. Both the first hand 42 and second hand 44 utilize a hook and loop fastener 43,45, such as Velcro™ to easily release and attach the first hand 42 and the second hand 44 to the attachment pole 50. The first hand 42 and the second hand 44 can also be a sewn loop for first hand 48 and a sewn loop for second hand 49 around the attachment pole 50, which however are not as easily releasable and attachable and must be slid off of the attachment pole 50. There is also an attachment webbing and harness 90 that further secures the mascot or character 40 to the attachment pole 50, which is described in greater detail in the FIG. 2C description. The attachment pole 50 can be attached to the vehicle V by rolling down a window W of the vehicle V, placing the attachment pole 50 on a glass edge of the window W and rolling-up the window W and holding the attachment pole 50 in place between the window W and the frame of the window W.

FIG. 2B illustrates a front perspective view of a mascot or character device 10 used in combination with a vehicle V attached to a attachment pole 50 on an exterior EX of a vehicle V, in accordance with one embodiment of the present invention. The mascot or character device 10 is attached to the attachment pole 50 extending from the exterior EX of a vehicle V by the first hand 42 and a first foot 46 on the same side of the first hand 42, as opposed to the mascot or character device 10 being attached to the attachment pole 50 by the first and second hands 42, 44. The first hand 42 and the first foot 46 utilize a hook and loop fastener 43,47, such as Velcro™ to easily release and attach the first hand 42 and the first foot 46 to the attachment pole 50. The first hand 42 and the first foot 46 can also be a sewn loop for the first hand 48 and a sewn loop for the first foot 41 around the attachment pole 50, which however are not as easily releasable and attachable and must be slid off of the attachment pole 50. All of the other features of the mascot or character device 10 are the same as described in the FIG. 2A, except that the mascot or character device 10 illustrated in FIG. 2B, does not have a jersey 60 on and is not attached to the attachment pole 50 by a first hand 42 and a second hand 44.

FIG. 2C illustrates a front perspective view of an attachment webbing and harness 90 for a mascot or character device 10 used in combination with a vehicle V that attaches to a attachment pole 50 on an exterior EX of the vehicle V, in accordance with one embodiment of the present invention. The attachment webbing and harness 90 has a harness portion 100 that is wrapped around the waist area of a mascot or character 40 being secured to the attachment pole 50. Two generally elongated strips 110 are attached to the harness portion 100 and a loop 120 is formed on the end of each of the generally elongated strips 110 to accommodate an attachment pole 50 that the attachment webbing and harness 90 will be attached to. The loops 120 are formed from hook and loop fasteners 122, such as Velcro™ that allow for the easy release and attachment of the attachment webbing and harness 90 to the attachment pole 50. The loops 120 can also be sewn loops 124 which however are not as easily releasable and attachable and must be slid off of the attachment pole 50. The attachment webbing and harness 90 allows for the vehicle V to travel at high speeds while still securing the mascot or character device 10 to the attachment pole 50 of the vehicle V.

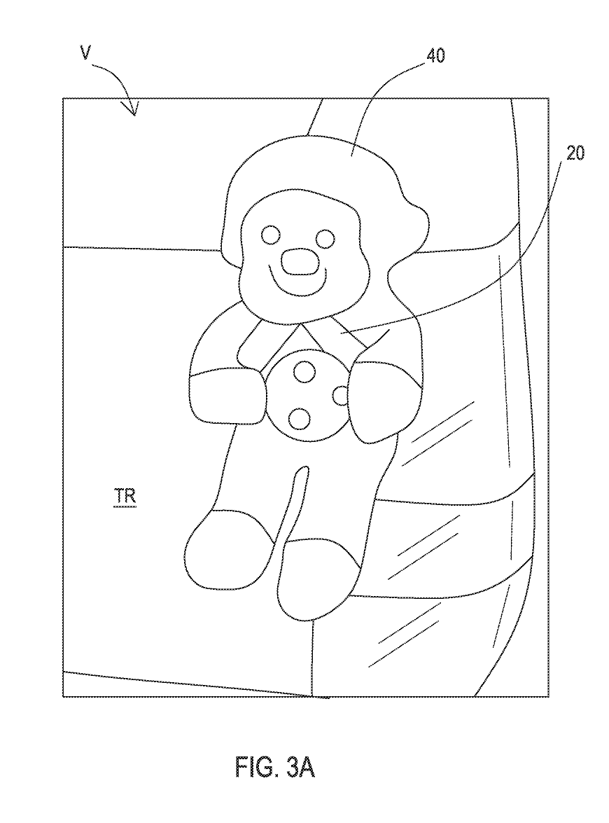

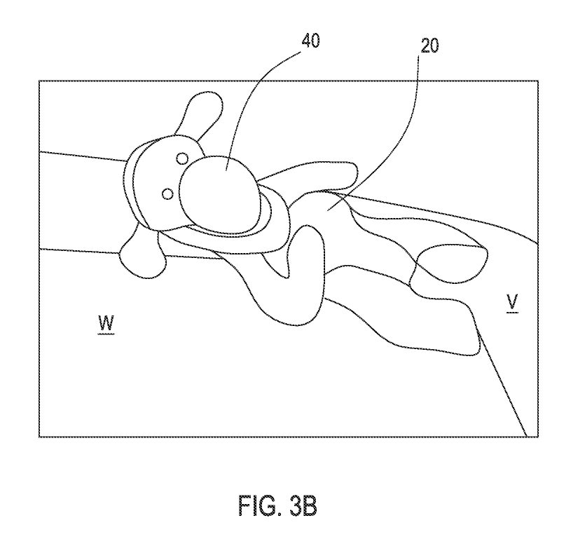

FIG. 3A illustrates a front perspective view of a mascot or character device 10 used in combination with a vehicle V attached to a trunk hinge TH of a vehicle V, in accordance with one embodiment of the present invention. The attachment assembly 20 illustrated and described in FIG. 1A and FIG. 1B can also be used to attach the mascot or character 10 to the exterior of a trunk TR, as is illustrated in FIG. 3A. The attachment assembly 20 is looped around the trunk hinge TH inside the trunk TR of the vehicle V and looped around an attached aperture (not shown) on the mascot or character device 10, while exposing the mascot or character 40 to the exterior EX of the vehicle V. The attachment assembly 20 and strap 30 can be closed over the trunk TR, allowing for the mascot or character 40 to be exposed to the exterior of the trunk TR. In another embodiment, the mascot or character 40 is simply attached to the exterior of the trunk TR of a vehicle V by a suction cup (not shown).

FIG. 3B illustrates a front perspective view of a mascot or character device 10 used in combination with a vehicle V where the mascot or character 40 is attached on the exterior of a window W, in accordance with one embodiment of the present invention. As illustrated in FIG. 3A, FIG. 1A and FIG. 1B, the attachment assembly 20 and strap 30 are used to secure the mascot or character 40 inside the vehicle V, while allowing the mascot or character 40 to be exposed to the exterior EX of vehicle V for display. The attachment assembly 20 is looped around any stable portion of the interior of the vehicle V and looped around an attached aperture on the mascot or character 40, while exposing the mascot or character 40 to the exterior EX of the vehicle V. The attachment assembly 20 and strap 30 can be closed over the window W, allowing for the mascot or character 40 to be exposed to the exterior of the trunk TR. In another embodiment, the mascot or character 40 is simply attached to the exterior of the W of a vehicle V by a suction cup (not shown).

The mascot or character device 10 is used to promote any special allegiance for sports teams, characters, or holiday spirit or other allegiance that is well known in the art. The mascot or character device 10 flies from the outside of the vehicle V and serves as a decoration and toy for adults and children. The mascot or character device 10 can also be used as a decoration for a room, locker, home and anywhere to promote spirit. The jerseys 60 and other accessories can also be changed as desired for fun and spirit.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A mascot or character device used in combination with a vehicle, with an attachment pole, comprising:
a mascot or character that includes a jersey; and
an attachment webbing and harness that secures said mascot or character to said attachment pole, said attachment webbing and harness has a harness portion that is wrapped around said mascot or character being secured to said attachment pole;
two generally elongated strips that are attached to said harness portion and a loop formed on an end of each said generally elongated strips to accommodate said attachment pole that said attachment webbing and harness is attached to.

2. The device according to claim 1, wherein said jersey is a football, a basketball or a soccer jersey.

3. The device according to claim 1, wherein said mascot or character hangs on said attachment pole by placing a first hand on said attachment pole, sliding an attachment accessory on said attachment pole and placing a second hand on said attachment pole.

4. The device according to claim 3, wherein said mascot or character hangs on said attachment pole by placing a first hand on said attachment pole, sliding said attachment accessory on said attachment pole and placing a first foot on said attachment pole.

5. The device according to claim 4, wherein said first hand and said first foot are secured to said attachment pole with a first set of hook and loop fasteners or a first set of sewn loops.

6. The device according to claim 3 or 4, wherein said attachment accessory can be removed at any time.

7. The device according to claim 3 or 4, wherein said mascot or character device does not require said attachment accessory.

8. The device according to claim 4, wherein a C-clamp is disposed on top of said attachment pole and secures said first hands, said first feet and said attachment accessory on said attachment pole.

9. The device according to claim 3, wherein said C-clamp is disposed on top of said attachment pole and secures both said hands and said attachment accessory on said attachment pole.

10. The device according to claim 3, wherein said attachment accessory is a basketball, a football, a golf ball, a hockey puck, a soccer ball, a bottle of beer, cola, pop or soda, a honey pot or a pineapple.

11. The device according to claim 3, wherein said hands are secured to said attachment pole with a second set of hook and loop fasteners or a second set of sewn loops on said hand.

12. The device according to claim 11, wherein said loops are formed from said second set of hook and loop fasteners that allow for easy release and attachment of said attachment webbing and harness to said attachment pole.

13. The device according to claim 1, wherein said attachment pole is made of plastic.

14. A mascot or character device used in combination with a vehicle, comprising:
an attachment assembly that includes a strap with an adjustable buckle where said strap can be pulled through said adjustable buckle at any length, said adjustable buckle has a male end that can be inserted into a female end forming said adjustable buckle; and
a mascot or character that includes a jersey.

15. The device according to claim 14, wherein said jersey is a football, a basketball or a soccer jersey.

16. The device according to claim 14, wherein sad attachment assembly is used to attach said mascot or character to an overhead handle in said vehicle.

17. The device according to claim 14, wherein said attachment assembly is used to attach said mascot or character to an overhead hook of said vehicle.

18. The device according to claim 14, wherein said attachment assembly is used to attach said mascot or character to said exterior of a trunk, where the attachment assembly is looped around a trunk hinge inside said trunk of said vehicle and looped around an attached aperture on said mascot or character device, while exposing said mascot or character to said exterior of said trunk.

19. The device according to claim 18, said attachment assembly is used to secure said mascot or character inside said vehicle, while allowing said mascot or character to be exposed to an exterior of a window, while said attachment assembly is looped around any stable portion of an interior of said vehicle and looped around said attached aperture on said mascot or character, while exposing said mascot or character to said exterior of said window.

20. A method for attaching a mascot or character device to an attachment pole of a vehicle, comprising the steps of:
rolling down a window of said vehicle;
placing said attachment pole on a glass edge of said window;
rolling-up said window; and
holding said attachment pole in place between said window and a frame of said window.
